(19) United States
(12) Patent Application Publication
(10) Pub. No.: US 2016/0344597 A1
(43) Pub. Date: Nov. 24, 2016

(54) EFFECTIVELY OPERATING AND ADJUSTING AN INFRASTRUCTURE FOR SUPPORTING DISTRIBUTED APPLICATIONS

(71) Applicant: Microsoft Technology Licensing, LLC, Redmond, WA (US)

(72) Inventors: Ming Zhang, Redmond, WA (US); Hongqiang Liu, Bellevue, WA (US); Jitendra D. Padhye, Redmond, WA (US); Ratul Mahajan, Seattle, WA (US); Srinivasa Aditya Akella, Middleton, WI (US); Raajay Viswanathan, Madison, WI (US); Matthew J. Calder, Pasadena, CA (US)

(21) Appl. No.: 14/720,653

(22) Filed: May 22, 2015

(51) Int. Cl. H04L 12/26; G06F 17/30; G06N 5/02; H04L 12/58

(52) U.S. Cl. CPC H04L 43/04; H04L 51/00; G06F 17/30943; G06F 17/3056; G06N 5/022

(57) ABSTRACT

A facility for managing distributed system for delivering online services is described. For each of a plurality of distributed system components of the first type, the facility receives operating statistics for the infrastructure component of the first type. For each of a plurality of distributed system components of a second type, the facility receives operating statistics for the infrastructure component of the second type. The facility uses the received operating statistics for distributed system components of the first and second types to generate a model predicting operating statistics for the distributed system for a future period of time.

### TECHNICAL FIELD

The described technology is directed to the field of digital resource management.

### BACKGROUND

An application program (“application”) is a computer program that performs a specific task. A distributed application is one that executes on two or more different computer systems more or less simultaneously. Such simultaneous activity is typically coordinated via communications between these computer systems.

One example of a distributed application is an email application, made up of server software executing on a server computer system that sends and receives email messages for users, and client software executing on a user's computer system that communicates with the server software to permit the user to interact with email messages, such as by preparing messages, reading messages, searching among messages, etc.

In some cases, server software executes on server computer systems located in one or more data centers. For users who are part of a distributed organization, a particular user's computer system, or “client,” may be connected to multiple datacenters by a wide-area network (“WAN”), such as one where network edge proxies, or “edge nodes,” that interact with clients are connected to data centers by WAN links.

### BRIEF DESCRIPTION OF THE DRAWINGS

FIG. 1 is a block diagram showing some of the components typically incorporated in at least some of the computer systems and other devices on which the facility operates.

FIG. 2 is a network diagram showing a typical infrastructure monitored, modelled, and managed by the facility in some embodiments.

FIG. 3 is a data flow diagram showing a sample data flow used by the facility in some embodiments to manage an infrastructure.

FIG. 4 is a flow diagram showing steps typically performed by the facility in some embodiments in order to maintain its model.

FIG. 5 is a flow diagram showing steps typically performed by the facility in some embodiments in order to adjust the operation of the infrastructure based up the model.

FIG. 6 is a flow diagram showing steps typically performed by the facility in order to modify the set of resources making up the infrastructure in a manner responsive to the model.

### SUMMARY

This summary is provided to introduce a selection of concepts in a simplified form that are further described below in the Detailed Description. This summary is not intended to identify key factors or essential features of the claimed subject matter, nor is it intended to be used to limit the scope of the claimed subject matter.

A facility for managing distributed system for delivering online services is described. For each of a plurality of distributed system components of the first type, the facility receives operating statistics for the infrastructure component of the first type. For each of a plurality of distributed system components of a second type, the facility receives operating statistics for the infrastructure component of the second type. The facility uses the received operating statistics for distributed system components of the first and second types to generate a model predicting operating statistics for the distributed system for a future period of time.

### DETAILED DESCRIPTION

The inventors have observed that infrastructures for supporting one or more distributed applications are both complex, and expensive to build and operate. Few effective tools exist for choosing particular infrastructure resources to allocate to particular users or groups of users in a way that best meets users' needs and limits overall costs.

Similarly, few effective tools exist for determining when particular resources in the infrastructure should be expanded—such as by adding a new WAN link—or contracted—such as by reducing the number of servers executing the server component of a particular application—in a way that best serves users while limiting cost.

To overcome these disadvantages, the inventors have conceived and reduced to practice a software and/or hardware facility (“the facility”) for modeling the operation, or “dynamics,” of an infrastructure for supporting one or more distributed applications or other online services. The facility constructs a time-based, stochastic model designed to predict future dynamics of the infrastructure based on past measurements of the infrastructure. The facility uses the model to predict future load, as a basis for allocating particular resources within the infrastructure-such as to particular users or groups of users—and adjusting the overall supply of resources within the infrastructure.

In some embodiments, a controller provided by the facility maintains an up-to-date view of the infrastructure's health and workload, and periodically configures each infrastructure component based upon that view. In some embodiments, this configuration determines the edge nodes used by users, the data centers used by edge nodes, and the WAN paths used by traffic between edge nodes and data centers.

In some embodiments, the model generated by the facility models infrastructure load and performance as a function of time. In some embodiments, the facility generates the model using a stochastic linear program, such as a second-order cone program.

In some embodiments, the facility applies the model to past measurements to obtain predictions that can be compared to later past infrastructure dynamics in order to determine overall prediction error—i.e., capturing the variance of the workload and performing upon it statistical multiplexing. The facility uses this prediction error to adjust predictions produced by the model in advance of their use to adjust allocation, making it highly likely that the facility will prevent congestion without having to overallocate resources.

In some embodiments, the facility implements resource reallocations that it determines in accordance with the model, also referred to as “load migrations,” in a gradual manner. As one example, in some embodiments, the facility reallocates clients to edge nodes only with respect to new network connections initiated by those clients.

Certain terminology used herein is described as follows. A “session” is one or more queries (over possibly multiple TCP connections) from the same user to the same service that follow a DNS lookup; queries after a succeeding lookup belong to a different session. DNS lookup is a useful marker because it allows the facility to direct the user toward the desired edge proxy. In some embodiments, the facility uses a short DNS time-to-live (“TTL”), such as 10 seconds, so that users perform new lookups after pauses in query traffic. A “user group” (“UG”) is a set of users that are expected to have similar relative latencies to particular edge proxies (e.g., because they are proximate in Internet topology). Operating at this granularity enables the facility to learn latencies at group-level rather than user-level, which can be more challenging. In some amounts, the facility defines UGs as clients having the same/24 IP address prefix.

The model predicting workload for an upcoming period is based upon workload information from previous periods. Measurement agents on DNS servers report the arrival rates of new sessions for each UG and each service; report on resource usage and departure rate of sessions; and measurement agents on network switches that face the external world report on non-edge traffic matrix (in bytes/second). Measurement agents on edge proxies capture edge proxy workload in terms of resource(s) that are relevant for allocation (e.g., memory, CPU, traffic). The facility uses exponentially weighted moving average (EWMA) to estimate workload for the next period. The facility also tracks the distribution of estimation errors (i.e., estimated minus actual), which the facility uses in the stochastic model. Also, in some embodiments, health monitoring services at proxy sites and data centers inform the controller how much total infrastructure capacity is lost.

By operating in some or all of the ways described above, the facility is often able to increase the capacity of an infrastructure to handle a greater number of transactions, and/or increase the performance of the infrastructure in handling transactions.

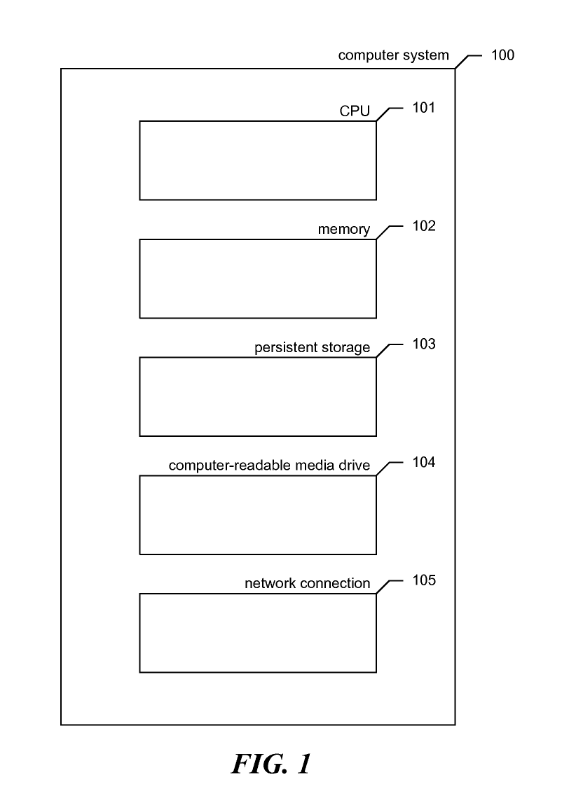

FIG. 1 is a block diagram showing some of the components typically incorporated in at least some of the computer systems and other devices on which the facility operates. In various embodiments, these computer systems and other devices 100 can include server computer systems, desktop computer systems, laptop computer systems, mobile phones, personal digital assistants, televisions, cameras, automobile computers, electronic media players, etc. In various embodiments, the computer systems and devices include zero or more of each of the following: a central processing unit (“CPU”) 101 for executing computer programs; a computer memory 102 for storing programs and data while they are being used; a persistent storage device 103, such as a hard drive or flash drive for persistently storing programs and data; a computer-readable media drive 104, such as a floppy, CD-ROM, or DVD drive, for reading programs and data stored on a computer-readable medium; and a network connection 105 for connecting the computer system to other computer systems to send and/or receive data, such as via the Internet or another network and its networking hardware. While computer systems configured as described above are typically used to support the operation of the facility, those skilled in the art will appreciate that the facility may be implemented using devices of various types and configurations, and having various components.

While various embodiments are described in terms of the environment described above, those skilled in the art will appreciate that the facility may be implemented in a variety of other environments including a single, monolithic computer system, as well as various other combinations of computer systems or similar devices connected in various ways.

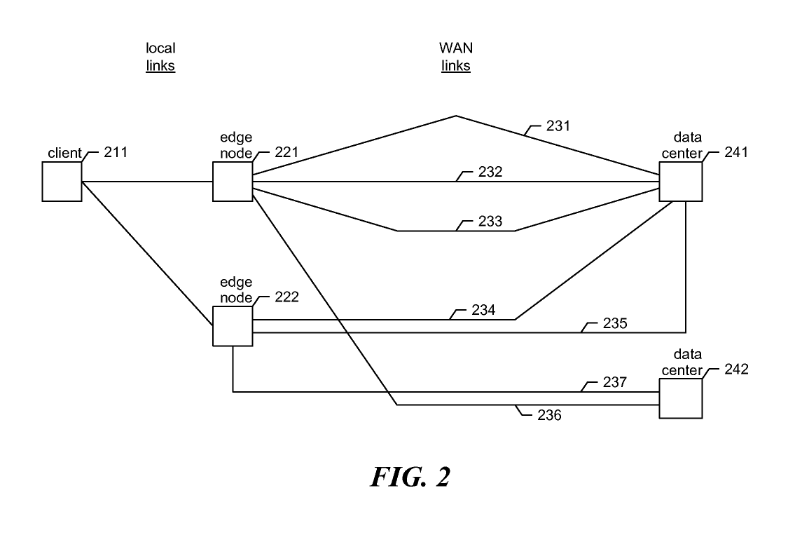

FIG. 2 is a network diagram showing a typical infrastructure monitored, modelled, and managed by the facility in some embodiments. The diagram shows one client 211 among a large number of clients served by the infrastructure. The client executes the client side of distributed software whose server side is hosted in data centers such as data center 240 and 241. Alternatively, the client consumes services hosted in these data centers that do not require a client application component. Each client connects to the infrastructure via an edge proxy node, such as an edge proxy nodes 221 and 222. These edge proxies serve clients as a gateway to the WAN links 231-237 that provide connections to remote data centers. The edge proxies in some cases terminate TCP or HTTP connections, and may cache content originating at the data centers in a location close to clients. As part of its operation, the facility determines, for each client or group of clients—i.e., user group: to which edge node they will connect; to which data center the requests will be sent; and via which WAN link or links these requests will be sent to the data center.

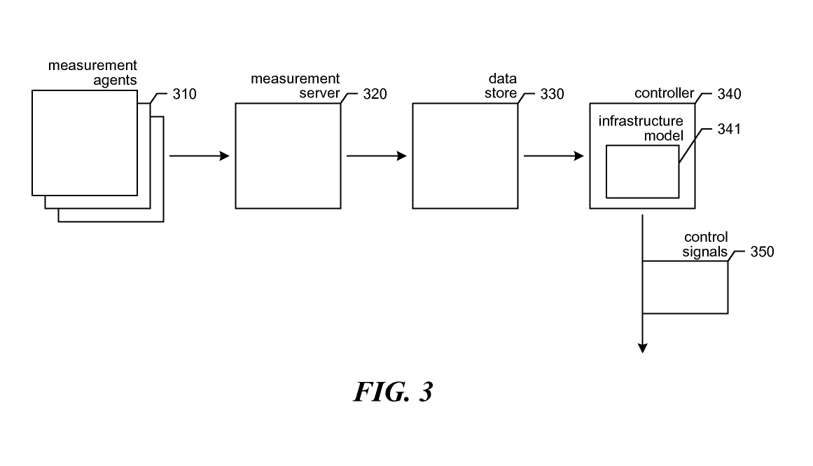

FIG. 3 is a data flow diagram showing a sample data flow used by the facility in some embodiments to manage an infrastructure. Measurement agents 310 make load and performance measurements throughout the infrastructure, such as in clients, edge nodes, WAN routers and switches, and data centers. The measurement agents transmits these measurements to a measurement server 320, which stores them in a data store 330. A controller 340 uses measurements from the data store to periodically update its model 341 of the infrastructure. The controller further uses the updated infrastructure model as a basis for control signals 350 for controlling the infrastructure. In various embodiments, control signals adjust ways in which existing resources of the infrastructure are allocated, and/or may be a basis for expanding or contracting various resources of the infrastructure in various ways.

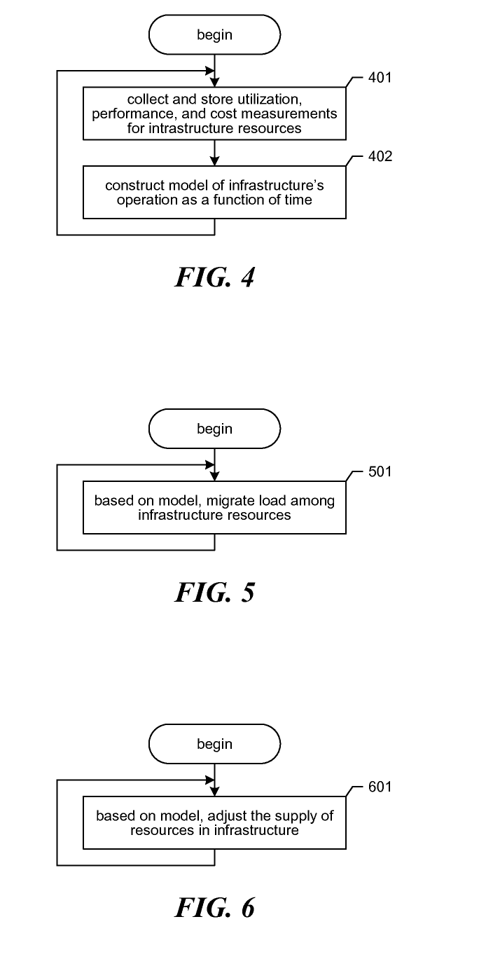

FIG. 4 is a flow diagram showing steps typically performed by the facility in some embodiments in order to maintain its model. In step 401, the facility collects and stores information about the infrastructure's resources' utilization, performance, and cost. In step 402, the facility constructs a model of the infrastructure's operation as a function of time. Additional details about step 402 are included below. After step 402, the facility continues in step 401.

Those skilled in the art will appreciate that the steps shown in FIG. 4 and in each of the flow diagrams discussed below may be altered in a variety of ways. For example, the order of the steps may be rearranged; some steps may be performed in parallel; shown steps may be omitted, or other steps may be included; a shown step may divided into substeps, or multiple shown steps may be combined into a single step, etc.

FIG. 5 is a flow diagram showing steps typically performed by the facility in some embodiments in order to adjust the operation of the infrastructure based up the model. In step 501, based upon the model, the facility migrates various aspects of infrastructure load among the infrastructure resources. Additional details of this migration are discussed below. After step 501, the facility continues in step 501.

FIG. 6 is a flow diagram showing steps typically performed by the facility in order to modify the set of resources making up the infrastructure in a manner responsive to the model. In step 601, based upon the model, the facility adjusts the supply of resources in the infrastructure. After step 601, the facility continues in step 601.

Additional details of the facility's implementation in various embodiments follow.

### Modeling Temporal Dynamics

The model of temporal load variations generated by the facility in some embodiments is described below. For ease of exposition, assume initially that the infrastructure hosts only service, which is present at all proxies and all DCs, and that there are no restrictions on mapping UGs to proxies and DCs. Also assume that there is only one bottleneck resource (e.g., memory) at proxies and DCs and that the capacity of this resource can be described in terms of the number of active sessions. Extension of the model to remove these assumptions follows below.

TABLE 1
Model Inputs

| | |
|---|---|
| G = {g} | Set of UGs |
| B = {b} | Set of edge load balancers (or entry points) |
| Y = {y} | Set of edge proxies |
| C = {c} | Set of DCs |
| L = {l} | Set of WAN links |
| M_{α} | Capacity of infrastructure component α |
| P = {p} | Set of WAN paths (tunnels) |
| Ψ = {ψ} | Set of e2e-paths ψ = (b, p_{by}, y, p_{yc}, c, p_{cy}, y, p_{yb}, b) |
| Θ = {θ} | Set of server tuples θ = (b, y, c) |
| h_{g,b} | Performance of g to entry point b |
| n_{g}⁰, n_{g,θ}⁰ | # old sessions of g at time period start; those using θ |
| T_{s,d}⁰ | Non-edge traffic from switch s to d at time period start |
| ã_{g}, d_{g} | Estimated session arrival, departure rate of g |

Table 1 above summarizes inputs to the model. A user session uses three “servers”—a load balancer b, edge proxy y, datacenter c—and four WAN paths—request and response paths between b and y (as y may be remote) and y and c. Each path is a pre-configured tunnel, i.e., a series of links from the source to destination switch; there can be multiple tunnels between switch pairs. The tuple (b, P_{by}, y, p_{yc}, c, p_{cy}, y, p_{yb}, b) is referred to as an end-to-end or e2e-path.

TABLE 2
Model Outputs

| | |
|---|---|
| π_{g,ψ} | Weight of new sessions of UG g on ψ |
| τ_{g,ψ} | Weight of old sessions of UG g on ψ |
| w_{s,d,p} | Weight of non-edge traffic from switch s to d on p |

Table 2 above summarizes outputs of the model, given current system state and estimated workload in the next time period. These are the fraction of each UG's new sessions that traverse each e2e-path, the fraction of each UG's existing sessions, and the fraction of non-edge traffic that traverse each network path. The computation is based on modeling the impact of output on user performance and the utilization of infrastructure components, as a function of time t relative to the start of the time period (0≦t≦T, where T is time period length).

### Modeling Server Utilization

Server utilization is impacted by existing sessions. There are n_{g}⁰ old sessions of g from the last time period, and d_{g} is their predicted departure rate. A device to put τ_{g,ψ} fraction of these sessions on e2e-path ψ causes the number of sessions to vary as:

∀g,ψ∈Ψ_{g}:n_{g,ψ}^{old}(t)=(n_{g}⁰−t*\tilde{d}_{g})τ_{g,ψ} (1)

The facility assumes that the departures are uniformly spread over the next time period, and thus n_{g}⁰≧T*\tilde{d}_{g}. The facility's variance handling absorbs any sub-time period variances in departure and arrival rates.

The facility captures impact of session affinity by mandating that the number of sessions for server tuples θ=(b,y,c) do not change when a time period starts, as follows:

$$∀ g , θ \text{:} {\sum }_{A ψ \text{:} θ ∈ ψ} {n}_{g , ψ}^{old} ( t = 0 ) = {n}_{g , θ}^{0} \qquad ( 2 )$$

For new sessions that arrive in next time period, ã_{g} is the net arrival rate (i.e., arrivals minus departures) of new sessions of g and the fraction of those put on ψ is π_{g,ψ}. The number of new sessions on i vary as:

∀ψ∈Ψ_{g}:n_{g,ψ}^{new}(t)=t*ã_{g}π_{g,ψ} (3)

Thus, the total number of sessions from g on ψ is:

∀g,ψ∈Ψ:n_{g,ψ}(t)=n_{g,ψ}^{old}(t)+n_{g,ψ}^{new} (4)

and the utilization of a server is:

$$∀ α ∈ B ⋃ Y ⋃ C \text{:} {μ}_{α} ( t ) = \frac{{\sum }_{∀ g} {\sum }_{∀ ψ ∈ {Ψ}_{g} : α ∈ ψ} {n}_{g , ψ} ( t )}{{M}_{α}} \qquad ( 5 )$$

### Modeling Link Utilization

Edge traffic load ũ_{g} (ũ_{g}^{r}) is the predicted request (response) traffic increase rate from new sessions, and \tilde{v}_{g} (\tilde{v}_{g}^{r}) is the predicted request (response) traffic decrease rate of old sessions. q_{g}⁰(r_{g}⁰) is the total request (response) traffic of g at t=0. These traffic rates are net effect of relevant sessions; individual sessions will have variability (e.g., whether the content is cached). The request traffic from g on e2e-path ψ varies as:

∀g,ψ∈Ψ_{g}:q_{g,ψ}(t)=t*ũ_{g}π_{g,ψ}+(q_{g}⁰−t*\tilde{v}_{g})τ_{g,ψ} (6)

where π_{g,ψ} and τ_{g,ψ} are weights for new and old sessions. Equation (6) above assumes for request and response traffic between load balancers and proxies is same as that between proxies and DCs. In cases where that is not true, however, the equation is accordingly modified.

For a link l, the total request traffic varies as:

$$∀ l \text{:} {q}_{l} ( t ) = {\sum }_{g} {\sum }_{ψ ∈ Ψ \text{:} l ∈ {p}_{ψ}} {q}_{g , ψ} ( t ) \qquad ( 7 )$$

Similarly, for response traffic:

$$\begin{matrix}∀ g , ψ ∈ {Ψ}_{g} \text{∷} {r}_{g , ψ} ( t ) = t * {\tilde{u}}_{g}^{r} {π}_{g , ψ} + ( {r}_{g}^{0} - t * {\tilde{v}}_{g}^{r} ) {τ}_{g , ψ} & ( 8 ) \\ ∀ l \text{:} {r}_{l} ( t ) = {\sum }_{g} {\sum }_{ψ ∈ Ψ \text{:} l ∈ {{p}^{r}}_{ψ}} {r}_{g , ψ} ( t ) & ( 9 )\end{matrix}$$

For non-edge traffic load, T_{s,d}⁰ is the predicted traffic from ingress switch s to egress switch d at t=0 and the predicted change rate is \tilde{c}_{s,d}. (If non-edge traffic is expected to not change substantially during the next time period, the facility uses \tilde{c}_{s,d}=0.) If w_{s,d,p} is the fraction of traffic put on network path p∈P_{s,d}, where P_{s,d} is the set of paths from s to d, the non-edge traffic from s to d on p varies as:

∀s,d,p∈P_{s,d}:o_{s,d,p}(t)=(T_{s,d}⁰+t*\tilde{c}_{s,d})w_{s,d,p} (10)

For a link l, the total non-edge traffic load varies as:

$$∀ l \text{:} {o}_{l} ( t ) = {\sum }_{{∀}_{s , d}} {\sum }_{∀ p ∈ {P}_{s , d} \text{:} l ∈ p} {o}_{s , d , p} ( t ) \qquad ( 11 )$$

Thus, the overall utilization of link 1 is:

$$∀ l \text{:} {μ}_{l} ( t ) = \frac{{q}_{l} ( t ) + {r}_{l} ( t ) + {o}_{l} ( t )}{{M}_{l}} \qquad ( 12 )$$

Finally, the facility uses these constraints for conservation of weights:

$$∀ g \text{:} {\sum }_{∀ ψ ∈ {Ψ}_{g}} {π}_{g , ψ} = 1 \qquad ( 13 )$$

The facility uses corresponding conservation constraints for τ_{g,ψ} and w_{s,d,p}.

### Optimization Objective

The facility seeks performance objectives by preferring traffic distributions with low delays, and seeks efficiency objectives by preferring traffic distributions with low utilization. The facility reconciles these requirements by penalizing high utilization in proportion to expected queuing delay it imposes. The facility uses a piece-wise linear approximation of the penalty function [symbol] (μ). The results are relatively insensitive to the exact shape—it can also differ across components—but the monotonically non-decreasing slope of the function is retained.

Thus, the objective function is:

$$min {\sum }_{α ∈ B ⋃ Y ⋃ C ⋃ L} {\int }_{0}^{T} 𝒫 ( {μ}_{α} ( t ) ) d t + {η}_{1} {\sum }_{l} {δ}_{l} {\int }_{0}^{T} {M}_{l} {μ}_{l} ( t ) d t + {η}_{2} {\sum }_{g , ψ , b ∈ ψ} {\int }_{0}^{T} {h}_{g , b} {n}_{g , ψ} ( t ) d t \qquad ( 14 )$$

The first term integrates utilization penalty over the time period; the second term, where δₗ is the propagation delay of link l, captures the propagation delay experienced by all traffic on the WAN; and the third term, in where h_{g,b} captures the performance of g to load balancer b, captures the performance of traffic in reaching the infrastructure. η₁ and η₂ are coefficients to balance the importance of different factors (default value=1).

### Solving the Model

The facility assigns values to the model's output variables by minimizing the objective under the constraints above. The model uses continuous time, and in some embodiments the facility ensures that the constraints hold at all possible times. Utilization of components linearly decreases or increases with time (due to arrival and departure rates being fixed during the time period). As a result, extreme utilizations occur at time period start or end. Thus, the constraints hold at all times if they hold at t=0 and t=T.

To efficiently handle the objective, since [symbol] (μ) is monotonic and convex, its first term is transformed using:

$${\int }_{0}^{T} 𝒫 ( {μ}_{α} ( t ) ) d t \leq \frac{𝒫 ( {μ}_{α} ( 0 ) ) + 𝒫 ( {μ}_{α} ( T ) ) \times T}{2} \qquad ( 15 )$$

Relying again on the linearity of the resource utilization, the second term (and similarly the third) are transferred using:

$${\int }_{0}^{T} {M}_{l} {μ}_{l} ( t ) d t = {M}_{l} \frac{( {μ}_{l} ( 0 ) + {μ}_{l} ( T ) ) \times T}{2} \qquad ( 16 )$$

This approach provides an efficiently-solvable LP. Its constraints are the ones listed earlier but enforced only at t=0,T. Its objective uses the transformations above and the piecewise approximation of [symbol] (μ).

### Handling Prediction Errors

SOCP is a convex optimization problem with cone-shaped constraints besides linear ones. The general format of conic constraints is \sqrt{Σᵢ₌₀ⁿ⁼¹xᵢ²}≦xₙ, where x₀, . . . , xₙ are variables. A cone can be shown in 3D space that results from \sqrt{x²+y²}≦z. Such constraints can be solved efficiently using the modern interior point method.

To translate the facility's model into a stochastic model and then to an SOCP, the facility models the workload as a random variable. This makes component utilizations random as well. The facility then obtains desirable traffic distributions by bounding the random variables for utilization.

To tractably capture the relationship between random variables that represent workload and those that represent utilization, it is assumed that prediction errors (i.e., differences from actual values) are normally distributed with zero mean. This assumption holds to a first order for a EWMA-based predictor. It is also assumed that the error distributions of different UGs are independent. Independence is not required for actual rates of UGs, which may be correlated (e.g., diurnal patterns). It is also not required for estimation errors for different resource (e.g., memory, bandwidth) needed by a UG (because different resource types never co-occur in a cone).

The facility's approach ensures that, even with prediction errors, the utilization of a component a does not exceed μ′_{α} (t) with a high probability p_{α} (such as 99.9%, for example). The facility computes μ′_{α} (t) based on the predicted workload. The deterministic LP above does not offer this guarantee if the workload is underestimated. Rather, the facility uses:

∀α∉B∪Y∪C∪L:P[μ^{α}(t)≦μ′_{α}(t)]≧p_{α} (17)

When prediction errors are normally distributed, components utilizations are too, as the sum of normally distributions is normally distributed. Thus, the requirement above is equivalent to:

∀α∉B∪Y∪C∪L:E[μ_{α}(t)]+Φ⁻¹(p_{α})σ[μ_{α}(t)]≦μ′_{α}(t) (18)

where Φ⁻¹ is the inverse normal cumulative distribution function of N(0,1), and E[μ_{α}(t)] and σ[μ_{α}(t)] are the mean and standard variance of μ_{α}(t) respectively. The facility computes E[μ_{α}(t)] as a function of the traffic that α carries, using equations similar to those in the temporal model. The facility computes σ[p_{α}(t)] as follows. Because n_{g,ψ} (t) is normally distributed, its standard variance is:

∀g,ψ∈Ψ_{g}:σ[n_{g,ψ}(t)]²=t²(σ[ã_{g}]²π_{g,ψ}²+σ[d_{g}]²τ_{g,ψ}²) (19)

Thus, for servers, the standard variances are:

$$∀ α ∈ B ⋃ Y ⋃ C \text{:} σ [ {μ}_{α} ( t ) ] = \frac{{\sqrt{{\sum }_{∀ g} {\sum }_{∀ ψ ∈ {Ψ}_{g} \text{:} α ∈ ψ} σ [ {n}_{g , ψ} ( t ) ]}}^{2}}{{M}_{α}} \qquad ( 20 )$$

Similarly, the standard variance for edge request traffic qₗ (t) on link l is:

$$∀ l \text{:} {σ [ {q}_{l} ( t ) ]}^{2} = {t}^{2} \times {\sum }_{{∀}_{g}} {\sum }_{∀ ψ ∈ {Ψ}_{g} \text{:} l ∈ ψ} {σ [ {\tilde{u}}_{g} ]}^{2} {π}_{g , ψ}^{2} + {σ [ {\tilde{v}}_{g} ]}^{2} {τ}_{g , ψ}^{2} \qquad ( 21 )$$

Thus, for links, the standard variance are:

$$∀ l \text{:} σ [ {u}_{l} ( t ) ] = \frac{\sqrt{{σ [ {q}_{l} ( t ) ]}^{2} + {σ [ {r}_{l} ( t ) ]}^{2} + {σ [ {o}_{l} ( t ) ]}^{2}}}{{M}_{l}} \qquad ( 22 )$$

where r₁(t) and o₁(t) are edge response and non-edge traffic. The facility computes their variance as in Eqn 21.

The quadratic formulations in Eqns. (18)-(22) are essentially cone constraints. For example, merging Eqn. (18), (19) and (20) produces:

$$\frac{t {Φ}^{1} ( {p}_{α} )}{{M}_{α}} \sqrt{{\sum }_{∀ g , ψ : α ∈ ψ} {σ [ {\tilde{a}}_{g} ]}^{2} {π}_{g , ψ}^{2} + {σ [ {\tilde{d}}_{g} ]}^{2} {τ}_{g , ψ}^{2}} \leq {μ}_{α}^{′} ( t ) - E [ {μ}_{α} ( t ) ]$$

The facility solves these constraints along with the earlier ones temporal model to obtain desired outputs. In the objective function (Eqn. 14), μ′_{α} is used instead of μ_{α}. The same principles as before are used to remove the dependence on time t.

### Implementing Computed Configuration

The facility converts the output of the model to new system configuration as follows. The DNS servers, load balancers, and proxies are configured to distribute the load from new sessions as per computed weights; their routing of old sessions remains unchanged. But two issues arise with respect to network switch configuration: weights differ for current and old sessions but switches do not know to which category a packet belongs; and weights are UG-specific, which would require UG-specific rules to implement, but the number of UGs can be more than switch rule capacity. The facility addresses both issues by having servers embed appropriate path (tunnel) identifier in each transmitted packet. Switches forward packets based on this identifier.

To scale computation, in some embodiments, the facility implements a few optimizations to reduce the size of the LP. A key is the large number of UGs (O(100K)). To reduce it, the facility aggregate UGs at the start of each time period. For each UG, the facility first ranks all entry points in decreasing order of performance and then combines into virtual UGs that have the same entry points in the top-three positions on the same order. The facility formulates the model in terms of VUGs. The performance of a VUG to an entry point is the average of the aggregate, weighted by UGs number of sessions. The variance of the VUG is computed similarly using the variance of individual UGs. Further, to reduce the number of e2e-paths per VUG, the facility limits each VUG to its best three entry points, each load balancer to three proxies, and each source-destination switch pair to six paths (tunnels). Together, these optimizations reduce the size of the LP by multiple orders of magnitude.

The facility also implements an SOCP-specific optimization. Given cone constraint of the form \sqrt{x₁²+x₂²+x₃²}≦x₄ for infrastructure component α, if |x₁|≦0.1% of α's capacity. The facility approximates it as |x₁|+\sqrt{x₂²×x₃²}≦x₄. Since \sqrt{x₁²+x₂²+x₃²}≦|x¹|+\sqrt{x₂²+x₃²}, this approximation is conservative. It is assuming worst case load for x₁, but it is a small fraction of capacity, it has minimal impact on the solution. This optimization reduces the number of variables inside cones by an order of magnitude.

In some embodiments, a computing system for tailoring the operation of an infrastructure for delivering online services is provided. The computing system comprises: a prediction subsystem configured to apply a stochastic linear program model to predict operating metrics for heterogeneous components of the infrastructure for a future period of time based upon operating metrics for a past period of time; and an adaptation subsystem configured to use the operating metrics predicted by the modeling subsystem as a basis for reallocating resources provided by the components of the infrastructure to different portions of a load on the infrastructure.

In some embodiments, a computer-readable medium is provided that has contents configured to cause a computing system to, in order to manage a distributed system for delivering online services: from each of a plurality of distributed system components of a first type, receive operating statistics for the infrastructure component of the first type; from each of a plurality of distributed system components of a second type distinct from the first type, receive operating statistics for the distributed system component of the second type; and use the received operating statistics for distributed system components of the first and second types to generate a model predicting operating statistics for the distributed system for a future period of time.

In some embodiments, a method in a computing system for managing a distributed system for delivering online services is provided. The method comprises: from each of a plurality of distributed system components of a first type, receive operating statistics for the infrastructure component of the first type; from each of a plurality of distributed system components of a second type distinct from the first type, receive operating statistics for the distributed system component of the second type; and use the received operating statistics for distributed system components of the first and second types to generate a model predicting operating statistics for the distributed system for a future period of time.

In some embodiments, a computer-readable medium storing an online services infrastructure model data structure is provided. The data structure comprises: data representing a stochastic system of linear equations whose solution yields a set of weights specifying, for each of a plurality of infrastructure resource types, for each of a plurality of combinations of (1) a group of client devices with (2) one of a plurality of infrastructure resource instances of the infrastructure resource type, the extent to which the group of client devices should be served by the infrastructure resource instance during a future period of time, the linear equations of this stochastic system being based on operating measurements of the infrastructure during a past period of time.

It will be appreciated by those skilled in the art that the above-described facility may be straightforwardly adapted or extended in various ways. While the foregoing description makes reference to particular embodiments, the scope of the invention is defined solely by the claims that follow and the elements recited therein.

1. A computing system for controlling the operation of an infrastructure for delivering online services, comprising:
a prediction subsystem configured to apply a stochastic linear program model to predict operating metrics for heterogeneous components of the infrastructure for a future period of time based upon operating metrics for a past period of time; and
an adaptation subsystem configured to use the operating metrics predicted by the modeling subsystem as a basis for reallocating resources provided by the components of the infrastructure to different portions of a load on the infrastructure.

2. The computing system of claim 1, further comprising a modeling subsystem configured to generate the model applied by the modeling subsystem.

3. The computing system of claim 1 wherein the applied model utilizes a second-order cone program.

4. The computing system of claim 1, further comprising a resource variation subsystem configured to use the operating metrics predicted by the prediction subsystem as a basis for adding and removing components of the infrastructure.

5. The computing system of claim 1 wherein the adaptation subsystem is configured to use the operating metrics predicted by the prediction subsystem as a basis for reallocating resources provided by the components of the infrastructure to different portions of a load on the infrastructure on a periodic basis.

6. The computing system of claim 1 wherein the prediction subsystem predicts operating metrics as a function of time.

7. The computing system of claim 1 wherein the adaptation subsystem is configured to reallocate resources to different portions of the load on the infrastructure in units including connections having creation times, and wherein the reallocation affects only connections created subsequent to the reallocation.

8. The computing system of claim 1 wherein the prediction subsystem is configured to apply the model in a manner to determine overall prediction error by performing statistical multiplexing on error distributions affecting different aspects of the infrastructure.

9. The computing system of claim 1 wherein the adaptation subsystem is further configured to use the operating metrics predicted by the modeling subsystem as a basis for selecting portions of demand on the infrastructure to reject.

10. A computer-readable medium having contents configured to cause a computing system to, in order to manage a distributed system for delivering online services:
from each of a plurality of distributed system components of a first type, receive operating statistics for the distributed system component of the first type;
from each of a plurality of distributed system components of a second type distinct from the first type, receive operating statistics for the component of the second type; and
use the received operating statistics for distributed system components of the first and second types to generate a model predicting operating statistics for the distributed system for a future period of time.

11. The computer-readable medium of claim 10 wherein the infrastructure components of the first type are wide area network entry points.

12. The computer-readable medium of claim 10 wherein the infrastructure components of the first type are data centers.

13. The computer-readable medium of claim 10 wherein the infrastructure components of the first type are wide area network links.

14. A computer-readable medium storing an online services infrastructure model data structure, the data structure comprising:
data representing a stochastic system of linear equations whose solution yields a set of weights specifying:
for each of a plurality of infrastructure resource types,
for each of a plurality of combinations of (1) a group of client devices with (2) one of a plurality of infrastructure resource instances of the infrastructure resource type,
the extent to which the group of client devices should be served by the infrastructure resource instance during a future period of time, the linear equations of this stochastic system being based on operating measurements of the infrastructure during a past period of time.

15. The computer-readable medium of claim 14 wherein the stochastic system of linear equations comprises a stochastic linear program model.

16. The computer-readable medium of claim 14 wherein the stochastic system of linear equations comprises a second-order cone program.

17. The computer-readable medium of claim 14 wherein the stochastic system of linear equations further determines overall prediction error by performing statistical multiplexing on error distributions affecting different aspects of the infrastructure.

18. The computer-readable medium of claim 17 wherein the weights yielded by the solution of the stochastic system of linear equations seek to limit the likelihood that the overall prediction error will cause a utilization rate for any infrastructure resource instance will exceed a threshold level.
